(19) United States
(12) Patent Application Publication
(10) Pub. No.: US 2002/0194499 A1
(43) Pub. Date: Dec. 19, 2002

(54) Method, system and apparatus for a portable transaction device

(76) Inventors: Yves Louis Gabriel Audebert, Los Gatos, CA (US); Jerome Antoine Marie Becquart, Fremont, CA (US)

Correspondence Address: STEVENS, DAVIS, MILLER & MOSHER, LLP, 1615 L Street, N.W., Suite 850, Washington, DC, 20036, US

(21) Appl. No.: 09/880,795

(22) Filed: Jun. 15, 2001

(51) Int. Cl. H04L 9/32

(52) U.S. Cl. 713/201

(57) ABSTRACT

A data processing method, system and apparatus for using an intelligent portable device as a credential storage and cryptographic service provider and business transactions terminal.

### FIELD OF INVENTION

The present invention relates to a data processing method and system for utilizing a portable intelligent device such as a digital cellular telephone, personal data assistant, laptop or other similar portable device incorporating a security token or its equivalent as a credential storage, cryptographic service provider and business transaction device.

### BACKGROUND OF INVENTION

The explosive growth in the use of portable intelligent devices has created demand for security mechanisms to be employed, which in many cases duplicates the security mechanisms already established for more traditional computer systems. One of the major security mechanisms being employed for portable devices involves the use of security tokens. Security tokens include smart cards, smart chip credit, charge and debit cards, subscriber identity modules (SIM) and wireless identity modules (WIM) all of which are designed to securely maintain end user credentials, cryptographic keys and other proprietary information.

The current art involving security tokens generally requires a dedicated hardware device interface to provide electrical power and communications between the security tokens and external devices As a consequence of this design limitation, it is currently necessary to remove a security token from one device interface and connect to another device interface associated with a second unrelated system in order to gain access or information from the second system.

There are several undesirable effects of having a dedicated device interface as follows.

A dedicated device interface limits the ability of a personal security device (PSD) to perform simultaneous or sequential transactions with service providers not accessible through the computer system in which the security token is connected. This limitation necessitates manually relocating a security token from one device interface to another.

Manual manipulations of security tokens are inconvenient and promulgate the use of separate or duplicate PSDs. The use of separate security tokens becomes a significant management issue as the proper token must be selected for a given service provider, each token must be separately maintained, each token may require an end user to remember a different personal identification number (PIN) or other user specific information and as more services are acquired the number of security tokens is unnecessarily increased.

Duplication of security tokens becomes a serious security issue if a card is lost or stolen. Depending on how a particular security token is used, there could be a considerable time delay between the time of loss and time it is discovered that a security token has been lost thus increasing the chances of unauthorized use.

Lastly, there are different configurations of security tokens and hardware interfaces, which limit the direct interchangeability between the various configurations, even though the operative portions of the token conform to the same international standards. For example, SIMs have been reduced in size to allow for smaller cellular telephones while wallet sized smart cards are still preferred in business applications where size is not of particular concern.

### SUMMARY OF INVENTION

This invention provides a system and method for using a common portable device for credential storage, provider of cryptographic services and business transactions device for use over a variety of systems without having to remove and reinsert a card into multiple device interfaces or maintain separate cards for each service provider. In this invention, common portable devices equipped with a security token or token emulating software (virtual token) including laptops, personal data assistants (PDA), two-way pagers and digital cellular telephones are used as token interfaces allowing authentication and other transactions to occur with a physical or virtual token, thus limiting the number of physical manipulations involving a card and further reducing the need to maintain multiple cards. In most instances, implementation of this invention requires only minimal changes to existing security mechanisms Virtual security tokens are used in devices unable to support physical security tokens and other than the additional software to support token emulation, the functionality of a physical and virtual security tokens should be considered identical. For simplicity, physical and virtual security tokens will be collectively referred to hereinafter as personal security devices (PSDs.)

To implement this invention, a local device connection or networking connection is established which allows a PSD to communicate with another computer system using a portable device as a communications interface. The connection to the computer system or other networked appliance may be accomplished using direct electrical connections, local wireless connections, local wireless networking or cellular networking with either or both a local computer system and/or a local terminal and an authentication server.

For purposes of this patent application, connections using direct electrical and wireless means are intended as peripheral device level connections while networking connections are computer-to-computer level connections as in peer-to-peer or client-server arrangements.

The authentication policies employed in this invention may include either or both asymmetric and symmetric keys as established by the security system protocols included for the protected computer system. The equivalent security protocols are likewise included in the PSD to coincide with the protected computer system security protocols.

The authentication policies may utilize either asynchronous or synchronous authentication methods as follows:

In asynchronous authentication methods, typically a client requests access to information contained on a server, the server generates a challenge to the client and the client generates a response, which is validated by the server.

In synchronous authentication methods, one-time password challenges are independently generated by a client and a sever utilizing a common standard (usually time), incrementing variables (e.g. number of logins) and a shared secret symmetrical key and compared by the server. More detailed discussions of synchronous authentication methods are provided in U.S. Pat. Nos. 5,802,176, 5,937,068 and 5,887,065 all of which were invented by one of the inventors of this patent application, assigned to the same assignee and herein incorporated by reference. As these patents thoroughly describe synchronous authentication methods, no further discussion will be provided.

However, it should be appreciated by one skilled in the art that either the asynchronous authentication method described herein or the synchronous authentication methods described in the aforementioned patents may be employed.

A two-factor authentication process is employed in this invention that first requires the end user to authenticate his or herself to the PSD by entering a personal identification number (PIN) or biometric result (e.g. fingerprint scan) via a user interface included with the portable device. End user authentication to the PSD may occur before or coincident with receipt of an authentication challenge by the PSD when using asynchronous authentication methods or before generation of an authentication challenge by the PSD when using synchronous authentication methods.

The authentication challenge may be a random number, a cryptogram containing a password or any combination of information which when processed using the agreed upon security mechanisms included in the PSD results in a valid authentication response. The valid authentication response is then returned to the challenging computer system directly or indirectly depending on the embodiment of the invention employed where it is compared with an expected response generated by the challenging computer system. Communications and command translation between high level languages and the low level application protocol data units (APDU) supported by the PSD is performed using API (middleware) level software installed in the portable device or separated from incoming communications packets by the middleware software.

In one embodiment of the invention, the authentication response is returned directly to the challenging server using the same telecommunications pathway in which the authentication challenge was received by the portable device. In another embodiment of the invention, the authentication response is displayed on the portable device's screen and is separately and manually entered into a local client for example as a one-time password.

In the first embodiment of the invention, a portable device and its associated PSD are locally connected to a computer system using either direct hardwire or local wireless connections. In this embodiment of the invention, the portable device behaves as an intelligent PSD interface, which communicates with the computer system as a hardware device peripheral.

An end user, attempting to log onto a local client in which the portable device and associated PSD are connected or installed as a device peripheral, causes an authentication challenge to be generated on an authentication server. The generated authentication challenge is then sent to the local client and routed to the portable device for processing by the PSD. If not previously accomplished, the PSD prompts the end user for a PIN and upon successfully authenticating the end user to the PSD, generates a valid authentication response, which is returned using the same connection pathway in which the challenge was received and compared with an expected response. If the authentication response matches the expected response, the end user is allowed to perform additional transactions.

In the second embodiment of the invention, a portable device and its associated PSD are connected to a computer system using digital cellular or other wireless networking means having internet interoperability using for example any of the common wireless protocols (TCP/IP, WAP, XML, HTML) or alternatively, capable of supporting short messaging services (SMS.) In this embodiment of the invention, the portable device operates independently of the protected computer system. As in the first embodiment of the invention, an end user attempting to log onto the protected computer system, causes an authentication challenge to be generated either locally or remotely via an authentication server.

However, in this embodiment of the invention, it is necessary to determine the destination of the challenge, which is accomplished by cross- referencing (via a lookup table or database) the user ID or its equivalent with a unique address associated with the end user's portable device. The unique address may be a network address, a telephone number, cellular telephone number or other unique identifier, which allows the generated challenge to be sent to the portable device. Once the unique address has been determined, the authentication challenge is then sent to the end user's portable device where API level software translates and directs the challenge into the PSD If not previously accomplished, the PSD prompts the end user for a PIN or biometric result and upon successfully authenticating the end user to the PSD, generates a valid authentication response that is either returned using the same connection pathway in which the challenge was received or exhibited on the portable device and separately entered into the local client for example as a one-time password. The challenging server then validates the authentication response. If the authentication response matches a predetermined expected response, the end user is allowed to perform additional transactions.

This arrangement also allows for a second level authorization where a user who has limited access capabilities requires approval to access a more secure processing function. By way of example, a bank teller may need to transfer a large amount of money for a customer from one account to another account but due to the size of the intended transaction, requires a managers approval. The manager's approval may be obtained by sending a challenge to the manager's portable device and once obtained, the transaction can continue. The advantage of this arrangement is that the manager does not need to be physically present in the bank. Any location that allows the manager to be in wireless contact with the bank will permit the second level authorization, thus providing better customer service.

It should be appreciated by those skilled in the art that more than one communications connection may be established with the portable device and PSD. For example, a digital cellular telephone equipped with short-range wireless (e.g. BlueTooth™, 802.11b, HomeRF, IrDA, etc.) or direct connection capabilities (hot synchronous cradle, serial, parallel, NIC, USB, telephone, etc.) may allow transactions to occur with the PSD using both a digital cellular connection and a short range wireless connection. Simultaneous transactions may be performed if the portable device is equipped with a multi-tasking operating system for example Microsoft Windows CE®, Symbian EPOC® or other multi-tasking operating systems. By using available wireless connectivity technologies, the portable device interface allows one or more connections to be addressed by multiple service providers using a telecommunications link without having to remove the PSD from the portable device.

In another embodiment of the invention, once authentications have been completed, the portable device may continue processing of business transactions with an internal host In which the end user has an existing employment or pecuniary relationship. Internal transactions could include accessing company records, email accounts, intranets, databases and the like. Other business transactions may also be accomplished using the portable device related to online retailing, financial services including online banking and securities trading, travel reservations, transferring digital music files and other available online services.

### BRIEF DESCRIPTION OF DRAWINGS

FIG. 1A—is a generalized system blocks diagram depicting the hardware aspects of the present invention.

FIG. 1B—is a generalized system block diagram depicting the software aspects of the present invention.

FIGS. 2A & B—are detailed block diagrams illustrating the portable device operating as a device peripheral and as a separate computer system.

FIG. 3—is a detailed block diagram illustrating multi-mode connection authentication.

FIG. 4A&B—are detailed block diagrams illustrating authentication transactions.

### DETAILED DESCRIPTION OF PREFERRED EMBODIMENT

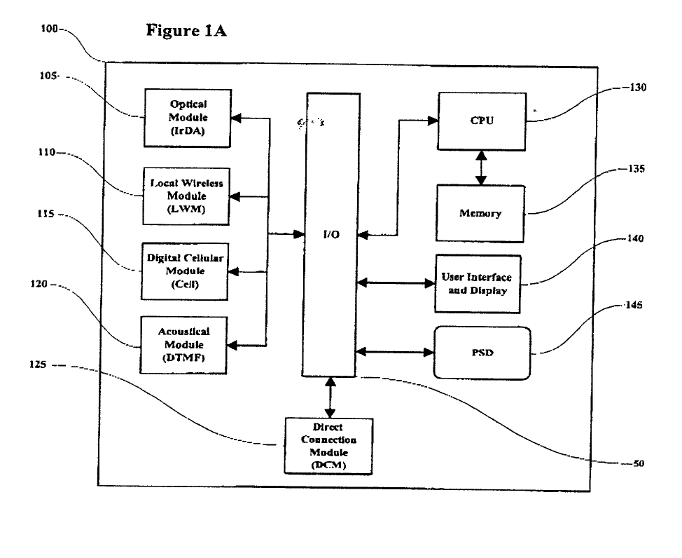

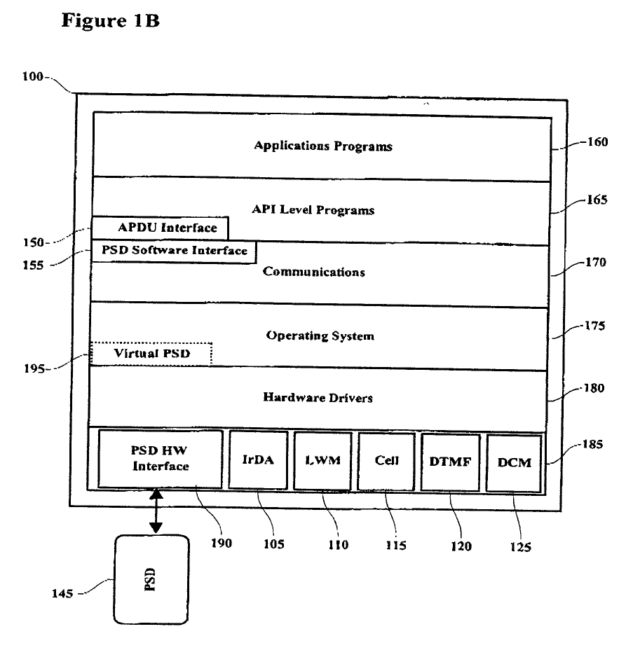

To practice this invention, a portable device equipped with a PSD and capable of direct electrical and wireless connections with one or more computer systems provides the means for a PSD to authenticate an end user to itself and subsequently to one or more computer systems. The connectivity modules described below are intended as examples of common connectivity methods employed by the various portable device manufacturers and are not intended to limit the invention to the connectivity methods contained herein. Referring to FIG. 1, a generalized block diagram of the invention, depicts an intelligent portable device 100 containing a central processor unit (CPU) 130 and associated memory 135 for performing data processing functions including generating responses to received authentication challenges. The operating system and other necessary software applications and data are stored in system memory.

In the preferred embodiment of the invention, the operating system supports multi-tasking of programs including support of multiple communications modules and connections. For example, an end user may be authenticated to more than one computer system by using a hardwire connection to a local client and a wireless connection to another remote computer system.

A user interface and display 140 allows an end user to provide input and displays processed information; an input/output bus 50, which is functionally connected to a plurality of communication modules 105-120, allows the transfer of data between the intelligent portable device 100 and one or more connected computer systems. The user interface 140 includes but is not limited to touch sensitive screens, keypads, biometric devices, keyboards, pens, and mice. The display includes but is not limited to liquid crystal, optical plasma, light emitting diode and cathode ray tube. The user interface 140 displays for example an “Enter PIN” user prompt to authenticate the end user to an associated PSD and allows input of the end user's PIN for authentication by the PSD. Alternately, a biometric result (e.g. fingerprint scan) may be used in lieu of a PIN.

An infrared optical module 105 which utilizes an infrared transceiver to communicate serially with one or more external computer systems and peripherals may be incorporated into the portable device. This type of module is in widespread use for portable devices conforming to IrDA standards and includes the hardware and software to support optical communications connections between the portable device and external computer systems. The optical module connects to one or more computer systems as a wireless computer peripheral.

A local wireless radio frequency module 110, which utilizes a low power radio transceiver, to communicate with one or more external computer systems and peripherals may be incorporated into the portable device. This type of module provides greater bandwidth and range than common optical connecting methods. The emerging standard for replacing a physical (hardwire) connection to a hardware device peripheral utilizes BlueTooth™ and equivalent technologies. BlueTooth™ and equivalent technologies allow the portable device containing the PSD to be addressed directly through a computer system's hardware device port and includes the hardware and software to support the short range radio frequency communications connections between the portable device and one or more external computer systems.

A digital cellular module 115 may also be incorporated into the portable device This module provides wide area wireless connectivity utilizing digital cellular telephone technologies such as PCS. GSM and 3G to connect with one or more remote computer systems. This module includes the hardware and software to support the digital cellular communications, SMS and/or WAP messaging services and cellular connections between the portable device and external computer systems.

An electro-acoustical 120 module may be incorporated into the portable device. This connectivity method is widely deployed using analog or digital modems to communicate with remote computer systems over standard telephone lines using dual tone modulated frequency (DTMF) technologies. In this invention, the portable device includes the ability to transmit and receive DTMF signals sent over a standard telephone line. This module includes the hardware and software to support electro-acoustical connections between the portable device and one or more external computer systems. This allows an end user to use the numeric keypad on a standard telephone or simulated keypad display for PIN entry.

A direct physical 125 connectivity module which is included in this invention provides for electrically connecting the portable device to a computer system utilizing standardized device interfaces such as serial, parallel, universal serial bus, PCMCIA, proprietary hot synchronous cradles and similar arrangements. In this embodiment of the invention, the portable device acts analogously to a smart card reader with the added capabilities of performing authentication and other transactions independent of the computer system in which the device is electrically connected. This module includes the hardware and software to support direct connections between the portable device and one or more external computer systems.

A PSD 145 is an intelligent device which contains a microprocessor for executing programmatic instructions, read only memory (ROM) for containing essential programs such as a runtime environment and security policies, non-volatile memory for storage of information using electrically erasable programmable read-only memory (EEPROM) and volatile random access memory (RAM) for temporary storage of information. Alternatively, for portable devices, which do not support a physical PSD, protected software emulation programs collectively called a virtual PSD are installed in the intelligent device, which provides the equivalent functionality of a physical PSD. Included in the PSD are programs that generate proper authentication responses to challenges directed to the PSD for asynchronous authentication policies or alternately generate a unique internal challenge when synchronous authentication policies are employed.

The PSD also provides authentication of an end user by requiring a proper personal identification number (PIN) or biometric result to be entered before generating an authentication response (asynchronous authentication) or unique internal challenge (synchronous authentication.) Common examples of current PSD technology include smart cards, smart chip credit, charge and debit cards, subscriber identity modules (SIM) and wireless identity modules (WIM). PSD interface connections are included in the portable device, which allows a physical PSD to operatively connect to the I/O bus of the portable device.

Referring now to FIG. 1B, a generalized system block diagram of the invention is depicted. The various layers shown are based on the Open System Interconnection model (OSI.) For simplicity, certain layers are not shown and should be assumed to be present and incorporated into adjacent layers. The layers associated with this invention include:

an Applications Layer 160 which generally contains higher level software applications (e.g. word processor) and a user interface and such as a graphical user interface (GUI);

an Applications Programming Interface level (API) 165 for processing and manipulating data for use by either higher or lower level applications. Included in this layer is a middleware program known as an APDU interface 150. The APDU interface translates high-level protocols directed to the PSD 145 into low-level APDU protocols and translates APDU protocols sent from the PSD into high-level protocols for use by API level 165 or Applications programs 160.

a Communications Layer 170 which contains communications programs including secure communications capabilities which enables a portable device to communicate with a other external computer systems to exchange information in an agreed upon protocol and visa versa. Included in this layer is a middleware program known as a PSD Software Interface 155. The PSD Software Interface directs APDU packets generated by the APDU Interface 150 to the PSD Hardware Interface 190 and directs APDU packets generated by the PSD 145 and sent through the PSD Hardware Interface 190 into the APDU Interface 155 for protocol conversion. In an alternate embodiment of the invention, a virtual PSD 195 replaces the physical PSD 145 and PSD Hardware Interface 190.

an Operating System Layer 175 or equivalent runtime environment, preferably multi-tasking, controls the allocation and usage of hardware resources such as memory, central processing unit (CPU) time, disk space, hardware I/O port assignments, peripheral device management, and virtual PSD 195;

a Hardware Driver Layer 180 permits the operating system to communicate and control physical devices connected to the portable device's hardware I/O bus;

and a Physical Device Layer 185 where the PSD hardware interface 190 and various communications devices, IrDA 105, local wireless module (LWM) 110, cellular module (cell) 115, electro-acoustical module (DTMF) and direct connection module (DCM) 125 are physically connected and in communications with the I/O bus 50 for the portable device as shown in FIG. 1A. The direct connection module (DCM) 125 may include for example, common hardwire connections such as a serial port, parallel port, universal serial bus, PCMCIA, telephone line or a network interface card.

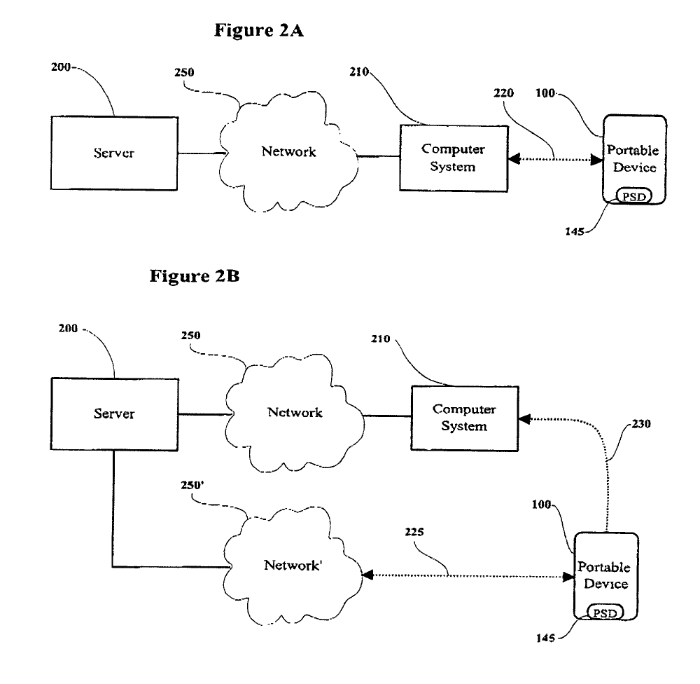

Referring to FIGS. 2A and 2B. there are two basic modes in which the portable device may operate, as a hardware device peripheral or as a separate computer system.

In FIG. 2A, the portable device connects to a computer system as a hardware device peripheral. All end user dialogs with the PSD (other than PIN or biometric result entry) are performed using the user interface for the computer system in which the portable device is connected. This mode of operation occurs when the portable device is directly connected to the local client using a hardware device interface (serial, parallel, USB, optical or wireless RF connection.)

In the preferred embodiment of the invention, an end user attempting to access the computer system at the local client 210 causes an authentication challenge to be generated by an authentication server 200. The challenge is sent over the network 250 to the local client 210 where a program directs the challenge through an I/O port assigned to the hardware device interface used to communicate with the portable device 100. The authentication challenge is transmitted over the device connection 220 to the portable device 100 where it is received, and processed by the portable device then routed to the PSD 145 or virtual PSD 195.

A program within the PSD prompts the user to enter a PIN or biometric result that authenticates the user to the PSD if not previously accomplished. For portable devices that lack a keypad, a program within the portable device displays an operative image of a keypad and data screen. Upon successfully authenticating the user to the PSD, the challenge is processed by the PSO using the pre-established authentication algorithm producing an authentication response. The authentication response is then returned to the challenging server using the same connection and processing pathway in which the challenge was received.

FIG. 2B, the portable device 100 operates independently of the computer system 210 as a separate computer system. End user dialogs occur primarily on the portable device and are sent via a separate networking connection 225 to a receiving authentication server 200. Alternately, the portable device may process an incoming authentication challenge and display a password, which is then manually entered 230 into the local client 210. This mode of operation occurs when the portable device is connected using networking connectivity methods such as digital cellular, standard or wireless networking, or using standard telephone service.

In this embodiment of the invention, an end user attempting to access a computer system 210 causes an authentication challenge to be generated by an authentication server 200. Programs on the server 200 cross references the user identification or it's equivalent with a unique address for the end user's portable device and PSD to generate a unique challenge using pre-established authentication criteria. The unique portable device address may be a network address, a cellular telephone number, or a standard telephone number. The challenge is then sent to the identified portable device address. In a typical networking environment, the unique address is a server assigned IP address.

The authentication challenge is sent out over a network 250 to the portable device. The network may be the same network 250, which connects the computer system 210 and authentication server 200 a separate network, a telephone network, or a digital cellular network.

For digital cellular telephone service, the authentication challenge is sent through an internet-cellular messaging gateway using an instant messaging protocol, for example an SMS flash message. When using standard telephone service, the portable device must be connected to the telephone line whose number is dialed by the authentication server in order for the portable device to receive the challenge via its internal analog or digital modem.

In the preferred embodiment, the authentication challenge generated is a random number which when processed by the PSD becomes a unique one-time password. The challenging server using the same or another pre-established authentication criteria determines an authentication result that will be compared with a returned authentication response. Optionally, the server may impose a time limit to receive a response to the issued authentication challenge.

Once the challenge is received and processed by the portable device 100, it is then routed to the PSD 145 or virtual PSD 195 for processing. If not previously accomplished, a program within the PSD prompts the user to enter a PIN or biometric result, which authenticates the end user to the PSD. For portable devices that lack a keypad, a program within the portable device displays an operative image of a keypad and data screen. Upon successfully authenticating the user to the PSD, the challenge is processed by the PSO using the pre-established authentication criteria producing an authentication response.

The authentication response is either directly returned to the challenging server using the established networking connection 225 or displayed on the user interface of the portable device for manual entry 230 into the local client and returned via the network connection 250 between the authentication server 200 and the client 210.

The authentication server authenticates the end user by comparing the received authentication response with the server-generated expected result. If the received response matches the server-generated expected result, the user is allowed access to the computer system, if the response does not match the server-generated result, then access is denied.

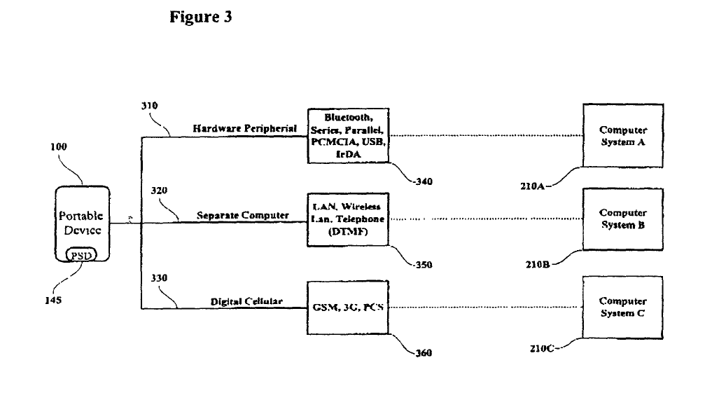

Referring to FIG. 3, an intelligent portable device 100 coupled with a PSD 145 and equipped with a multi-tasking operating system may be used to perform multiple authentications and business transactions by establishing connections as a hardware peripheral 310, (e.g. Bluetooth™, Series, Parallel PCMCIA, USB, IrDA 340) as a separate computer system 320 (LAN. Wireless LAN, Telephone 350) or connecting using digital cellular radio 330 (GSM, 3G, PCS 360) to one or more remote computer systems 210A, 210B, 210C.

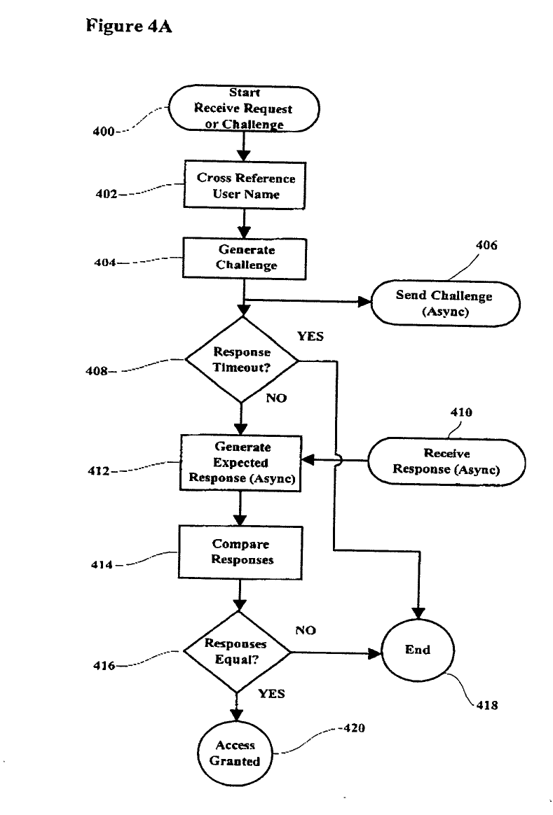

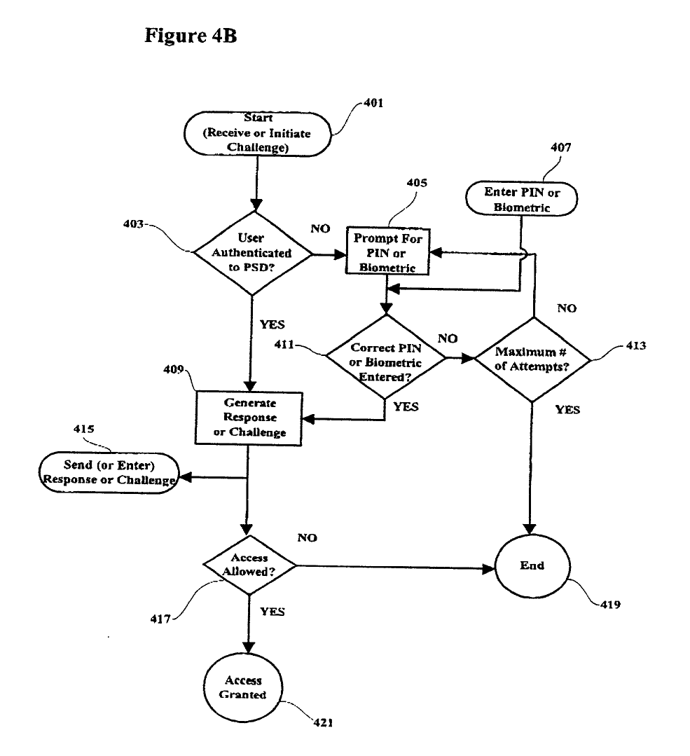

Referring to FIGS. 4A and B, the authentication process is illustrated. In FIG. 4A, the authentication challenge process is initiated 400 by a login process at the local client which initiates a request at an authentication server (or a local challenge if synchronous authentication methods are employed.) The server causes a program to cross reference 402, a user name or equivalent login identification with a unique identifier associated with the user's portable device. The cross referencing program may be located on the local client or on a separate authentication server.

A challenge 404 is then generated and sent 406 to the portable device associated with the user's unique identifier. The challenge may include a random number, a random number encrypted with ether a shared secret (synchronous) key, the end user's public key or another cryptography arrangement shared between the challenging server and the user's PSD. The challenging server then awaits a response back from the PSD. Optionally, if a response is not received within a predetermined time limit 408, the authentication session is ended 418.

Referring to FIG. 4B, the response portion of the authentication process begins when the challenge is received 401. The PSD determines if the end user has previously been authenticated to the PSD 403. If not, the PSD prompts 405 the end user to enter a PIN or biometric result using the display or scanner associated with the portable device. Using the appropriate user interface for the portable device, the end user enters the PIN or biometric result 407 that is compared with an internally generated or stored value 411. If the entered value does not match the internal PSD generated value, the authentication process is ended. Optionally, if the entered value does not match the internal PSD generated value, the end user is again prompted 405 to enter the PIN or biometric result and the process is repeated until either the correct PIN or biometric result is entered or a preset number of failed PIN or biometric result entry attempts has occurred 413.

If the number of allowed failed PIN or biometric result entry attempts has been exceeded, the authentication process is ended 419. If the entered PIN or biometric result matches the PSD internal value, an authentication response 409 is generated and sent 415 to the challenging server either using the same communications pathway in which the challenge was received or in an alternative embodiment of the invention, the authentication response is displayed on a screen included with the portable device, viewed by the end user, and manually entered into the protected computer system as a password

Referring again to FIG. 4A, the authentication response generated by the PSD is sent from the portable device and received 410 by the challenging server. Using the shared security mechanism, the challenging server generates an expected response 412 and compared 414 with the received response 410. if the responses 416 are equal, access is granted 420 to the computer system. If the responses are not equal the attempted login session is terminated 418.

Referring again to FIG. 4B, if access is allowed 417, the user will be allowed to continue processing 421, if otherwise, the authentication session ends 419.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. Other variations and embodiments are possible in light of above teachings, and it is not intended that this Detailed Description limit the scope of invention, but rather by the claims following herein.

What is claimed:

1. A data processing system for performing authentications and business transactions comprising:
a predetermined authentication policy which is shared between at least one server and a PSD; wherein the predetermined authentication policy is functionally stored within the PSD and server;
at least one server configured to perform authentications according to the predetermined authentication policy and further configured to support at least one network connection; wherein the server is functionally connected to at least one client over at least one network connection;
at least one local client configured to support a plurality of local device connections and at least one network connection; wherein the client is functionally connected to at least one server over at least one network connection;
an intelligent portable device configured to support a PSD, a plurality of local device connections and a plurality of network connections; and
the PSD which is functionally connected to the intelligent portable device and configured to generate authentication information according to the predetermined authentication policy.

2. The system according to claim 1, wherein an end user sends an authentication request from the client to the server over the network.

3. The system according to claim 2, wherein the server, responsive to the authentication request sent by an end user from the client, authenticates the end user using the predetermined authentication policy.

4. The system according to claim 1, wherein the intelligent device is functionally connected to the client through at least one local device connection and further configured as a hardware device peripheral which allows the PSD to communicate authentication information with the server using the network connection.

5. The system according to claim 4, wherein the local device connection between the client and intelligent portable device is selected from the group consisting of a direct connection, an optical connection, wireless RF connection or electro acoustical connection.

6. The system according to claim 3, wherein the predetermined authentication policy includes asynchronous authentication means, synchronous authentication means and cryptography means.

7. The system according to claim 5, wherein at least a second client functionally connected to a second server may connect with the intelligent portable device as a hardware device peripheral allowing use of the predetermined authentication policy shared with the PSD and the server.

8. The system according to claim 1, wherein the intelligent device is functionally connected to at least one network in common with the server and configured as an independent portable device which allows the PSD to communicate authentication information with the server over at least one network connection.

9. The system according to claim 2, wherein the authentication request includes at least one unique identifier associated with the end user.

10. The system according to claim 9, wherein the unique identifier is used by the server for locating and communicating with the intelligent portable device associated with the end user.

11. The system according to claim 9, wherein the unique identifier is used by the server for locating and communicating with another intelligent portable device associated with a second level approver.

12. The system according to claim 8, wherein the network connection between the server and intelligent portable device is selected from the group consisting of a wireless RF network or digital cellular network.

13. The system according to claim 8, wherein a first portion of authentication information is sent over a first network connecting the intelligent portable device with the server and a second portion of the authentication information is sent over a second network connecting the client with the server.

14. The system according to claim 12, wherein the intelligent portable device connects to at least a second server over at least one networking allowing use of the predetermined authentication policy shared with the PSD and the second server.

15. The system according to claim 7 or 14, wherein a plurality of network and local device connections are facilitated using the intelligent portable device.

16. The system according to claim 15, wherein plurality of authentications are facilitated using the shared predetermined authentication policy.

17. The system according to claim 16, wherein a plurality of local device connections, a plurality of network connections and a plurality of authentications are facilitated using the intelligent portable device

18. A method for performing authentications and business transactions comprising:
networking an intelligent portable device including a functionally connected PSD to at least one server using a network connection; wherein a shared predetermined authentication policy is functionally stored in the server and PSD,
initiating an authentication request by an end user at the client,
sending the request to a server, wherein the client and the server are functionally connected by a network,
authenticating the end user using the predetermined authentication policy,
allowing the end user access to the network following successful authentication for purposes of performing additional transactions.

19. The method according to claim 18, wherein the intelligent portable device is configured as a hardware device peripheral.

20. The method according to claim 18, wherein the intelligent portable device is configured as an independent intelligent portable device.

21. The method according to claim 18, wherein the predetermined authentication policy includes asynchronous authentication means and cryptography means.

22. The method according to claim 18, wherein the predetermined authentication policy includes synchronous authentication means and cryptography means.

23. The method according to claim 18, further comprising end user authentication to the PSD by entry of a PIN.

24. The method according to claim 18, further comprising end user authentication to the PSD using a biometric result.

25. The method according to claim 23 or 24, wherein the entry is conducted using a user interface and display associated with the intelligent portable device.

26. The method according to claim 23 or 24, wherein the entry is conducted using a user interface and display associated with the client.

27. The method according to claim 23 or 24, wherein exceeding a maximum number of attempts at authentication ends the authentication process.

28. The method according to claim 21, wherein exceeding a predetermined response time ends the authentication process.

29. The method according to claim 18 further comprising business transactions.

30. An intelligent portable data processing device for performing authentications and business transactions comprising:
a user interface, a display, data processing means, data storage means, authentication means, business transaction means, a plurality of local device connection means, a plurality of network connection means, PSD interfacing means and a PSD.

31. The device according to claim 30, wherein the authentication means includes a predetermined authentication policy, which is functionally stored in the PSD and shared with at least one additional server.

32. The device according to claim 30, wherein the device is functionally connected to at least one client using at least one local device connection means.

33. The device according to claim 30, wherein the device is functionally connected to at least one server using at least one network connection means.

34. The device according to claim 30, wherein the device is functionally connected to at least one local client using at least one local device connection means and functionally connected to at least one server using at least one network connection means.

35. The device according to claim 30, wherein the device is functionally connected to a plurality of local clients using at least one local connection means.

36. The device according to claim 30, wherein the device is functionally connected to a plurality of servers using at least one network connection means.

37. The device according to claim 30, wherein the device is functionally connected to a plurality of local clients using at least one local connection means and functionally connected to multiple servers using at least one network connection means

38. The PSD according to any one of the preceding claims wherein the PSD is a physical device.

39. The PSD according to claim 38, wherein the PSD is a virtual device.
